(19) United States
(12) Patent Application Publication
(10) Pub. No.: US 2018/0232473 A1
(43) Pub. Date: Aug. 16, 2018

(54) METHODS, SYSTEMS, AND COMPUTER PROGRAM PRODUCTS FOR DETERMINING THE EFFECT OF TURBULENCE ON AN ENTITY

(71) Applicant: Corvid Technologies LLC, Mooresville, NC (US)

(72) Inventors: Gregory McGowan, Mooresville, NC (US); Michael Anderson, Davidson, NC (US)

(21) Appl. No.: 15/896,967

(22) Filed: Feb. 14, 2018

Related U.S. Application Data
(60) Provisional application No. 62/458,791, filed on Feb. 14, 2017.

(51) Int. Cl. G06F 17/50

(52) U.S. Cl. CPC G06F 17/5009; G06F 2217/16; G06F 17/5095

(57) ABSTRACT

A method includes performing operations as follows by a processor; determining a location of an entity within a simulated turbulence, determining induced angles imposed on the entity, wherein determining the induced angles includes mapping velocity vectors of the simulated turbulence onto the entity, determining total angles imposed on the entity, wherein determining the total angles includes adding the mean angles imposed on the entity in an absence of the simulated turbulence to the induced angles, determining a total loading imposed on the entity based on the total angles imposed on the entity, and determining an incremental loading imposed on the entity, wherein determining the incremental loading includes subtracting a mean loading imposed on the entity in the absence of simulated turbulence from the total loading.

### CROSS-REFERENCE TO RELATED APPLICATION

The present application claims priority to U.S. Provisional Patent Application Ser. No. 62/458,791, filed Feb. 14, 2017, the entire content of which is incorporated by reference herein as if set forth in its entirety.

### BACKGROUND

The present disclosure relates to the effects of turbulence and, more particularly, to the effects of turbulence resulting from one entity being in proximity to another entity.

Turbulence is generally referred to as “turbulent flow,” or the movement of a fluid, such as a gas or liquid, in which the fluid undergoes irregular mixing. This irregular mixing may cause changes in the fluid's speed, pressure, and/or direction. By contrast, “laminar flow” refers to fluid movement with generally constant speed, direction, and pressure.

The movement of two entities relative to each other in a fluid may disturb the fluid creating turbulence, which may impose forces and/or moments on one or both of the entities and/or other bodies or structures.

### SUMMARY

In some embodiments of the inventive concept a method comprises performing operations as follows by a processor: determining a location of an entity within a simulated turbulence, determining induced angles imposed on the entity, wherein determining the induced angles comprises mapping velocity vectors of the simulated turbulence onto the entity, determining total angles imposed on the entity, wherein determining the total angles comprises adding the mean angles imposed on the entity in an absence of the simulated turbulence to the induced angles, determining a total loading imposed on the entity based on the total angles imposed on the entity, and determining an incremental loading imposed on the entity, wherein determining the incremental loading comprises subtracting a mean loading imposed on the entity in the absence of simulated turbulence from the total loading.

In other embodiments, the induced angles comprise an angle-of-attack and a yaw angle.

In still other embodiments, mapping the velocity vectors comprises determining a centroid of the entity and selecting the velocity vectors as being ones of a plurality of velocity vectors that are closest to the centroid of the entity.

In still other embodiments, determining the induced angles comprises determining turbulence velocities at the centroid, wherein determining the turbulence velocities at the centroid comprises performing a trilinear interpolation of the velocity vectors that were selected and determining the induced angles based on the turbulence velocities at the centroid.

In still other embodiments, the method further comprises modifying the induced angles using a coupling factor.

In still, other the entity is an aircraft and the coupling factor is based on Max Munk's induction factor.

In still other embodiments, the entity is an aircraft and the coupling factor is based on Oswald's efficiency factor.

In still other embodiments, determining the total loading comprises performing bilinear interpolation of the total loading in a loading information repository that relates loading of entity to an applied freestream turbulence vector.

In still other embodiments, determining the incremental loading comprises determining incremental force outputs in each of three dimensions and determining incremental moment outputs in each of the three dimensions.

In still other embodiments, the entity is a portion of an aircraft.

In some embodiments of the inventive concept, a method comprises performing operations as follows by, a processor: determining a partition of an entity that defines a plurality of entity sections and performing operations as follows for each respective one of the plurality of entity sections: determining a location of a respective one of the plurality of entity sections within a simulated turbulence, determining induced, angles imposed on the respective one of the plurality of entity sections, wherein determining the induced angles comprises mapping velocity vectors of the simulated turbulence, onto the respective one of the plurality of entity sections, determining total angles imposed on the respective one of the plurality of entity sections, wherein determining the total angles comprises adding the mean angles imposed on the respective one of the plurality of entity sections in an absence of the simulated turbulence to the induced angles, determining a total loading imposed on the respective one of the plurality of entity sections based on the total angles imposed on the respective one of the plurality of entity sections, and determining an incremental loading imposed on the respective one of the plurality of entity sections, wherein determining the incremental loading comprises subtracting a mean loading imposed on the respective one of the plurality of entity sections in the absence of simulated turbulence from the total loading, and determining an incremental loading imposed on the entity, wherein determining the incremental loading imposed on the entity comprises summing the incremental loading determined for each respective one of the plurality of entity sections.

In further embodiments, the induced angles comprise an angle-of-attack and a yaw angle.

In still further embodiments, mapping the velocity vectors comprises: determining centroid of the respective one of the plurality of entity sections and selecting the velocity vectors as being ones of a plurality of velocity vectors that are closest to the centroid of the respective one of the plurality of entity sections.

In still further embodiments, determining the induced angles comprises determining turbulence velocities at the centroid, wherein determining the turbulence velocities at the centroid comprises performing a trilinear interpolation of the velocity vectors that were selected and determining the induced angles based on the turbulence velocities at the centroid.

In still further embodiments, the method further comprises modifying the induced angles using a coupling factor.

In still farther embodiments, the entity is an aircraft and the coupling factor is based on Max Munk's induction factor.

In still further embodiments, the entity is an aircraft and the coupling factor is based on Oswald's efficiency factor.

In still further embodiments, the entity is an aircraft, the respective one of the plurality of entity sections corresponds to a wing section of the aircraft, and the coupling factor is represented by a decay function, the decay function being based, on a proximity of the wing section of the aircraft to a fuselage of the aircraft.

In still further embodiments, the decay function comprises one of a linear decay function, a polynomial decay function, and an exponential decay function.

In still further embodiments, determining the total loading comprises per forming bilinear interpolation of the total loading in a loading information repository that relates loading of the respective one of the plurality of entity sections to an applied freestream turbulence vector.

In still, further embodiments, the entity is an aircraft.

In some embodiments of the inventive concept, a system comprises a processor and a memory coupled to the processor and comprising computer readable program code embodied in the memory that is executable by the processor to perform operations comprising: determining a location of an entity within a simulated Parbulonee, determining induced angles imposed on the entity, wherein determining the induced angles comprises mapping velocity vectors of the simulated turbulence onto the entity, determining total angles imposed on the entity, wherein determining the total angles comprises adding the mean angles imposed on the entity in an absence of the simulated turbulence to the induced angles, determining a total loading imposed on the entity based on the total angles imposed on the entity, and determining an incremental loading imposed on the entity, wherein determining the incremental loading comprises subtracting a mean loading imposed on the entity in the absence of simulated turbulence from the total loading.

In some embodiments of the inventive concept, a computer program product comprises a tangible computer readable storage medium comprising computer readable program code embodied in the medium that is executable by a processor to perform operations comprising: determining a location of an entity within a simulated turbulence, determining induced, angles imposed on the entity, wherein determining the induced angles comprises mapping velocity vectors of the simulated turbulence onto the entity, determining total angles imposed on the entity, wherein determining the total angles comprises adding the mean angles imposed on the entity in an absence of the simulated turbulence to the induced angles, determining a total loading imposed on the entity based on the total angles imposed on the entity, and determining an incremental loading imposed on the entity, wherein determining the incremental loading comprises subtracting a mean loading imposed on the entity in the absence of simulated turbulence from the total loading.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter may become apparent to one with skill in the art upon review of the following, drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including a turbulence analysis server for determining the effect of turbulence on art entity in accordance with some embodiments of the inventive concept;

FIG. 2 is a diagram of an airplane that illustrates the angle-of-attack (α) and the yaw or slip angle (β);

FIG. 3 illustrates a data processing system that may be used to implement the turbulence analysis server of FIG. 1 in accordance with some embodiments of the inventive concept;

FIG. 4 is a block diagram that illustrates a software/hardware architecture for use in a document analysis server for determining the effect of turbulence on an entity in accordance with some embodiments of the inventive subject matter;

FIG. 5 is a diagram that illustrates the application of a velocity vector from a wake or turbulence to a section of an entity in accordance with some embodiments of the inventive concept;

FIG. 6 is a graph that illustrates the interference factor for modifying induced angles using various decay rate models in accordance with some embodiments of the inventive concept; and

FIG. 7 is a flowchart that illustrates operations for determining the effect of turbulence on an entity in accordance with some embodiments of the inventive concept.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, the term “load” may refer to a force and/or a moment.

As used herein, the term “data processing facility” includes, but it is not limited to, a hardware element, firmware component, and/or software component. A data processing system may be configured with one or more data processing facilities.

Embodiments of the inventive concept are described herein by way of example in which a first aircraft flies in proximity to another aircraft, such as in a mid-air refueling scenario. The tanker aircraft may generate wind turbulence, which may induce incremental loads on the receiving aircraft that is being refueled. It will be understood, however, that embodiments of the inventive concept are not limited to aircraft, but are applicable generally to scenarios in which turbulence may result from one entity being in proximity to another entity in the presence of a fluid, such as a liquid or gas.

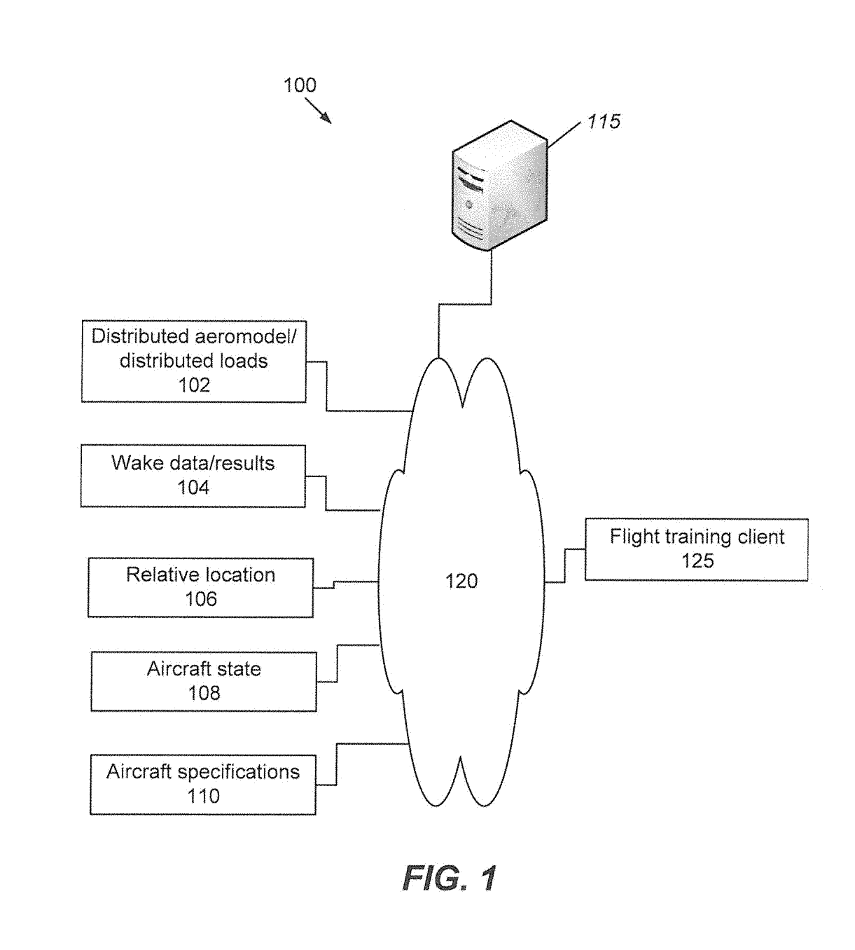

Referring to FIG. 1, a communication network 100 including a turbulence analysis server 115 comprises input information source repositories distributed aeromodel 102, wake data/results 104, relative location 106, aircraft state 108, and aircraft specifications 110 that are coupled to the turbulence analysis server 115 via a network 120. The communication network further includes a flight training client 125 that may receive output information from the turbulence analysis server 115. The network 120 may be a global network, such as the Internet or other publicly accessible network. Various elements of the network. 120 may be interconnected by a wide area network, a local area network, an Intranet, and/or other private network, which may not be, accessible by the general public. Thus, the communication network 120 may represent a combination of public and private networks or a virtual private network (VPN). The network 120 may be a wireless network, a wireline network, or may be a combination of both wireless and wireline networks. Moreover, the distributed aeromodel 102, wake data/results 104, relative location 106, aircraft state 108, and/or aircraft specifications 110 information repositories may be connected directly to the turbulence analysis server 115 without going through the network 120 in other embodiments of the inventive concept. Similarly, the flight training client 125 may be connected directly to the turbulence analysis server in still other embodiments of the inventive concept. It will be appreciated that in accordance with various embodiments of the inventive concept, the turbulence analysis server 115 may be implemented as a single server, separate servers, or network of servers either co-located in a server farm, for example, or located in different geographic regions.

As shown in FIG. 1, some embodiments according to the inventive concept can operate in a logically separated client side server side-computing environment, sometimes referred to hereinafter as a client/server environment. The client/server environment is, a computational architecture that involves a client process (Le., flight training client 125) requesting service from a server process (Le., turbulence analysis server 115). In general, the client/server environment maintains a distinction between processes, although client and server processes may operate on different machines or on the same machine. Accordingly, the client and server sides of the client/server environment arc referred to as being logically separated. Usually, when client and server processes operate on separate devices, each device can be customized for the, needs of the respective process. For example, a server process can “run on” a system having large amounts of memory and disk space, whereas the client process often “runs on” a system having a-graphic user interface provided by high-end video cards and large-screen displays,

The clients and servers can communicate using a standard communications mode, such as Hypertext Transport Protocol (HTTP), SOAP, XML-RPC, and/or WSDL. According to the HTTP request-response communications model, HTTP requests are sent from the client to the server and HTTP responses are sent from the server to the client in response to an HTTP request. In operation, the server waits for a client to open a connection and to request information, sue h as a Web page. In response, the server sends a copy of the requested information to the client, closes the connection to the client, and waits for the next connection. It will be understood that the server can respond to requests from more than one client. In some embodiments of the inventive concept, the turbulence analysis server 115 and the flight training client 125 may include respective communication modules that may facilitate the transfer of estimated induced, loading information on an aircraft that is caused by the effects of turbulence to the flight training client 125.

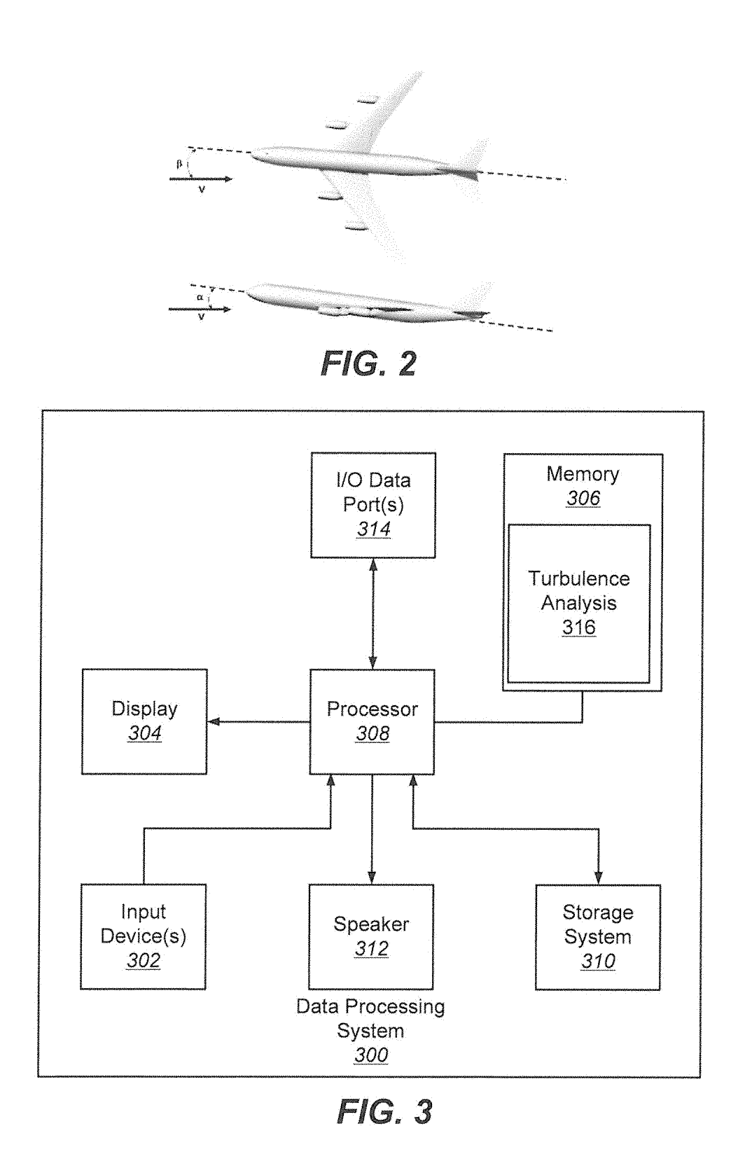

As described above, the turbulence analysis server 115 may receive input information from the distributed aeromodel 102, wake data/results 104, relative location 106, aircraft state 108, and/or aircraft specifications 110 information repositories. These information repositories may be databases, servers, wired/wireless devices, terminals, and the like that may be used to provide information to the turbulence analysis server 115. The distributed aeromodel information repository 102, which may be referred to as the distributed loads database, may be a table and/or a reduced math model that provides information on the loading, applied to the aircraft based on the aircraft's orientation relative to the freestream wind vector. The wake data/results information repository 104 may comprise wake turbulence data from testing and/or experimentation or results from modeling and/or simulation. This information may include wake or turbulence induced velocity components (u_{ind}, v_{ind}, and w_{ind}), which are used to calculated induced angles of attack and yaw/sideslip (α_{ind}, and β_{ind}). In some embodiments, the wake data/results information repository 104 may further include: i) wake/turbulence frequency content information including frequency and amplitude, ii) a time history of the wake/turbulence, and/or iii) a reduced math model of the wake time history. The relative location information repository 106 may comprise the location of aircraft within the wake/turbulence dataset (e.g., the distance of the aircraft from the tanker). The aircraft state information repository 108 may identify the mean orientation of the aircraft with respect to the freestream wind vector (v) in terms of angle of attack (α) and yaw/sideslip (β) as shown in FIG. 2. The aircraft specifications information repository 110 may comprise details about the aircraft geometry including, but not limited to, Aspect ratio (AR), wing span (b), Oswald's efficiency factor (s), and Leading edge sweep angle (Λ_{L}) if e is unknown.

The turbulence analysis server 115 may be configured to generate the incremental forces (F) and/or moments (M) based on the input information from the distributed aeromodel 102, wake data/results 104, relative location 106, aircraft state 108, and/or aircraft specifications 110 information repositories, which may be output in the principle axis directions (six scalar outputs: FX, FY, FZ, MX, MY, MZ). These increments in forces and moments may be provided to the flight training client 125. The flight training client 125 may be representative of a variety of different aircraft training systems, simulation systems, and the like for both autopilots and pilots. These aircraft training systems may include, but are not limited to the following types of training applications:

Training data for autopilot development, including inputs for machine learning algorithms

Training data for human pilot simulations

Aircraft response to turbulence (gust, commercial travel)

Formation flight, including training, automation, and warning systems

Swarming flight profile optimization

Swarming flight coordination algorithms, including inputs for machine learning algorithms

Optimize flight patterns for airport operations

Autopilot training/development (either via GNC Engineers or machine learning algorithms)

Ship airwake interactions (carrier operations)

Aircraft gust response

Flight response in urban environments (i.e. around buildings)

Training for thermal navigation (i.e. soaring flight, or range extension)

Training for towed aircraft applications (i.e. sailplanes, countermeasures)

In addition, as described above, embodiments of the inventive concept are not limited to the effects of turbulence on aircraft, but are applicable generally to the effects of turbulence resulting from two entities being in proximity to each other in a fluidic environment. Thus, the flight training client 125 may be general training client that is used for other applications, such as underwater applications (e.g., operations in close proximity of ship water wake, underwater structures, or other turbulent disturbances). In other embodiments of the inventive concept, the turbulence analysis server 115 may be configured to receive shearing force and bending moment information at user specified locations, which may be used to estimate structural loading through the operational envelope.

Although FIG. 1 illustrates an exemplary communication network including a turbulence analysis server 115 for determining the effect of turbulence on an entity, it will be understood that embodiments of the inventive subject matter are not limited to such configurations, but are intended to encompass any configuration capable of carrying out the operations described herein.

Referring now to FIG. 3, a data processing system 300 that may be used to implement the turbulence analysis server 115 of FIG. 1, in accordance with some embodiments of the inventive concept, comprises input device(s) 302, such as a keyboard or keypad, a display 304, and a memory 306 that communicate with a processor 308. The data processing system 300 may further include a storage system 310, a speaker 312, and an input/output (I/O) data port(s) 314 that also communicate with the processor 308. The storage system 310 may include removable and/or fixed media, such as floppy disks, ZIP drives, hard disks, or the like, as well as virtual storage, such as a RAMDISK. The data port(s) 314 may be used to transfer information between the data processing system 300 and another computer system or a network (e.g., the Internet). These components may be conventional components, such as those used in many conventional computing devices, and their functionality, with respect to conventional operations, is generally known to those skilled in the art. The memory 306 may be configured with a turbulence analysis module 316 that may provide functionality that may include, but is not limited to, facilitating the estimation of forces and moments on an entity resulting from the entity's interaction with a turbulence or wake field.

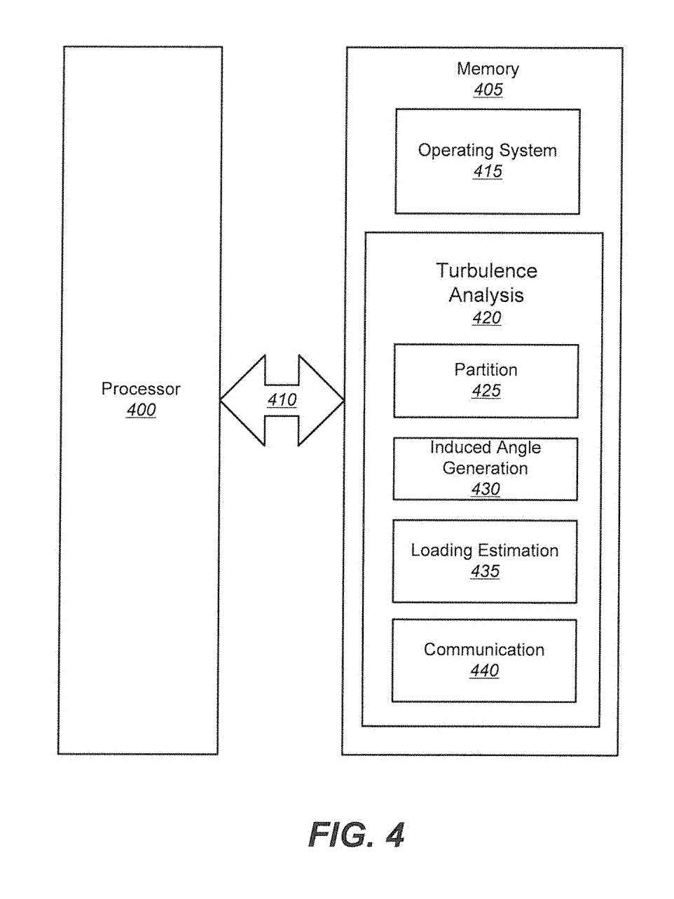

FIG. 4 illustrates a processor 400 and memory 405 that may be used in embodiments of data processing systems, such as the turbulence analysis server 115 of FIG.1 and the data processing system 300 of FIG. 3, respectively, for determining the effect of turbulence on an entity in accordance with some embodiments of the inventive concept. The processor 400 communicates with the memory 405 via an address/data bus 410. The processor 400 may be, for example, a commercially available or custom microprocessor. The memory 405 is representative of the one or more memory devices containing the software and data used for determining the effect of turbulence on an entity in accordance with some embodiments of the inventive concept. The memory 405 may include, but is not limited to, the following types of devices: cache, ROM, PROM, EPROM, EEPROM, flash, SRAM, and DRAM.

As shown in FIG. 4, the memory 405 may contain two or more categories of software and/or data: an operating system 415 and a turbulence analysis module 420. In particular, the operating system 415 may manage the data processing system's software and/or hardware resources and may coordinate execution of programs by the processor 400. The turbulence analysis module 420 may comprise a partition module 425, an induced angle generation module 430, loading estimation module 435, and a communication module 440.

The partition module 425 may be configured to take each component of an entity for which the effects of turbulence are to be determined, such as an aircraft receiving fuel from a tanker aircraft, and break the particular component down into individual slices referred to as sections. Thus, an aircraft may be broken down into fuselage, wing, vertical tail, etc. Each section is associated with loads specified in the distributed aeromodel or distributed loads information repository 102 based on the mean orientation of the aircraft specified in aircraft state information repository 108.

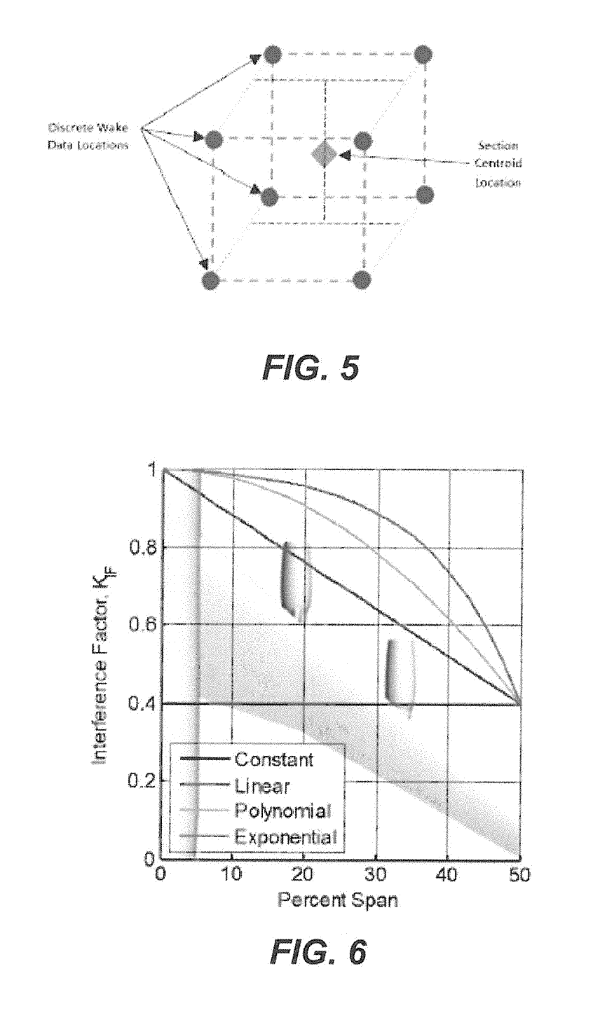

The induced angle generation module 430 may be configured to map turbulence disturbances, i.e., fluid velocity vectors, such as wind velocity vectors in the case of an aircraft, obtained from the wake data/results information repository 104 onto each section of each component. The mapping assumes that the aero disturbance acts locally at the respective section's geometric centroid. The process of mapping the wake/turbulence information may comprise finding the closest eight points in the wake data/results information repository 104 that surround the centroid's location and performing standard trilinear interpolation. This process is illustrated, for example, in FIG. 5 in accordance with some embodiments of the inventive concept. The data that are extracted from the wake data/results information repository are the x, y, and z components of the velocity. Once the wake velocities are known at the centroid's location, the data can be used to determine the induced angles, α_{ind} and β_{ind}, which are impinging on the section.

In some embodiments of the inventive concept, the induced angle generation module 430 may be further configured to modify the determined induced angles to account for low-speed coupling effects that can occur in an asymmetric fluidic flow field. This coupling factor is designed to reintroduce the effect of having the receiver aircraft present in a wake or turbulence field, which was evaluated and data collected or results generated in absence of the receiver. The coupling factor, which may be referred to as the interference factor (K_{IF}), may use Max Munk's induction factor as the basis for modifying the induced angles. Max Munk's factor (M_{f}) for, an elliptical wing, which is given in Equation. 1, is shown to be a function of the wing aspect ratio, AR, and can be calculated for any aircraft. The wing aspect ratio AR may be calculated in accordance with Equation 2, where b is the wing span and Sref is the wing area. Equation 3 is a slight modification to Max Munk's factor of Equation 1 to account for the non-elliptical wing loading that is typically present in most aircraft.

Mf=(1+2/AR)⁻¹ (1)

AR=b²/Sref (2)

K_{IF}(1+2/eAR)⁻¹ (3)

The major modification in Equation 3 is the inclusion, of Oswald's efficiency factor, e, which accounts for non-optimal lift distributions generated by the aircraft This factor is typically known by manufacturers, but an approximation may be used for aircraft for which the value of e is not known. Such approximations are provided in Equation 4a for a straight wing and Equation 4b for a swept wing.

e=1.78(1−0.45AR^{0.68})−0.64 (4a)

e=4.61(1−0.045AR^{0.68})(cos(Λ_{LE}))^{0.15}−3.1 (4b)

The factor K_{IF}, which is specific to the aircraft geometry, is then multiplied with the induced angles, α_{ind} and β_{ind}, for all components and sections of the aircraft,

For relatively large wing spans, such as, for example, the wing span of the Boeing B-52 Stratofortress, the tip effects are largely localized to the outboard sections of the wings. Thus, K_{IF} may vary across the wing span where near the wing tips the full K_{IF} value will be used while at the root section K_{IF} will approach 1.0 such that no factor is applied at the root. The models for this spanwise variation may, in accordance with various embodiments of the inventive concept, be based on linear decay, polynomial decay, and/or exponential decay. Each model may be evaluated to determine which is best for a particular application or environment. Equations for each model, are set forth below as Equations 5a through 5d and are illustrated in FIG. 6.

Constant: K_{IFD}=K_{IF} (5a)

Linear: K_{IFD}=1−(1−K_{IF})(2y/b) (5b)

Poly: K_{IFD}=1−(1−K_{IF})(2y/b)² (5c)

Exponential: K_{IFD}=1+(1−K_{IF})(1−exp(λ*2y/b))/(exp(λ)−1) (5d)

The loading estimation module 435 may be configured to determine the additional loading that is imposed on an entity, such as an aircraft, due to turbulence or wake based on the distributed aeromodel or distributed loads information repository 102 and the induced angles, α_{ind} and β_{ind}, that are determined by the inducted angle generation module 430. The loading estimation module 435 may use a technique called the total angle technique in which the mean angles, αₘₑₐₙ and βₘₑₐₙ, for the current aircraft flight conditions, i.e., the mean angles for the current position of the aircraft in the turbulence) awe, which may be obtained from the aircraft state information repository 108 and the relative location information repository 106, respectively, are added to the induced angles, α_{ind} and β_{ind}, for a particular section of a component to obtain total angles α_{Total} and β_{Total}. The total angles, α_{Total} and β_{Total}, may then be used to perform bilinear interpolation in the distributed aeromodel or distributed loads information repository 102 to, obtain the total forces and moments acting on the particular section. The loads corresponding to the mean state of the aircraft may then be subtracted from the total forces and moments or total loads to obtain the incremental forces and moments or incremental loads due to, the wake or turbulence. The aforementioned technique in which an incremental determination is performed near the mean may provide a more accurate estimate of the incremental loading as compared to determining the incremental loads based solely on the induced angles, α_{ind} and β_{ind}.

The incremental loads may be determined for each section of each component by determining the total loading for the respective section and subtracting the mean loading for the respective section. The incremental loads may be summed across all of the sections and components to obtain the six scalar loading outputs FX, FY, FZ, MX, MY, MZ, representing the incremental force and moments imposed on the aircraft as a result of the wake or turbulence for a particular position in the wake or turbulence field. The relative position of the aircraft in the wake or turbulence field may be updated and the operations repeated to obtain incremental loading due to the turbulence or wake for the new position. The incremental force or moment may be represented generally as set forth in Equation 6 in accordance with some embodiments of the inventive concept:

dF_{dist}=Σⱼ₌₁^{N}^{_{c}}Σᵢ₌₁^{N}^{ₛ}(Fᵢⱼ(εₘ+εᵢⱼ))−F_{AC}_{ₘ} (6)

Where dF_{dist} is the increment in force or moment due to the wake or turbulence flow, N_{c} is the total number of components, Nₛ is the total number of sections, Fᵢⱼ(εᵢⱼ) is the force on the ith section and the jth component due to a disturbance magnitude of ε, and F_{ACm} is the aerodynamic force and moment at the aircraft's mean state, which can be obtained through distributed aeromodel or distributed loads information repository 102. As explained above, the technique in which an incremental determination is performed near the mean may provide a more accurate estimate of the incremental loading as compared to determining the incremental loads based solely on the induced angles, α_{ind} and β_{ind}, particularly when dealing with non-linear regions of the flight envelope.

The communication module 440 may be configured to facilitate communication between the turbulence analysis server 115 and the distributed aeromodel 102, wake data/results 104, relative location 106, aircraft state 108, and/or aircraft specifications 110 information repositories. The communication module 440 may also be configured to facilitate communication between the turbulence analysis server 115 and the flight training client 125.

Although FIG. 4 illustrates hardware/software architectures that may be used in data processing systems, such as the document analysis server 115 of FIG. 1 and the data processing system 300 of FIG. 3, respectively, for determining the effect of turbulence on an entity in accordance with some embodiments of the inventive concept, it will be understood that embodiments of the present invention are not limited to such a configuration but are intended to encompass any configuration capable of carrying out operations described herein.

Computer program code for carrying out operations of data processing systems discussed above with respect to FIGS. 1, 3, and 4 may be written in a high-level programming language, such as MATLAB, Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the document analysis server 115 of FIG. 1 the data processing system 300 of FIG. 3, and the hardware/software architecture of FIG. 4, may each be implemented as a single processor system, a multi-processor system, a multi-core processor system, or even a network of stand-alone computer systems, in accordance with various embodiments of the inventive subject matter. Each of these processor/computer systems, may be referred to as a “processor” or “data processing system.”

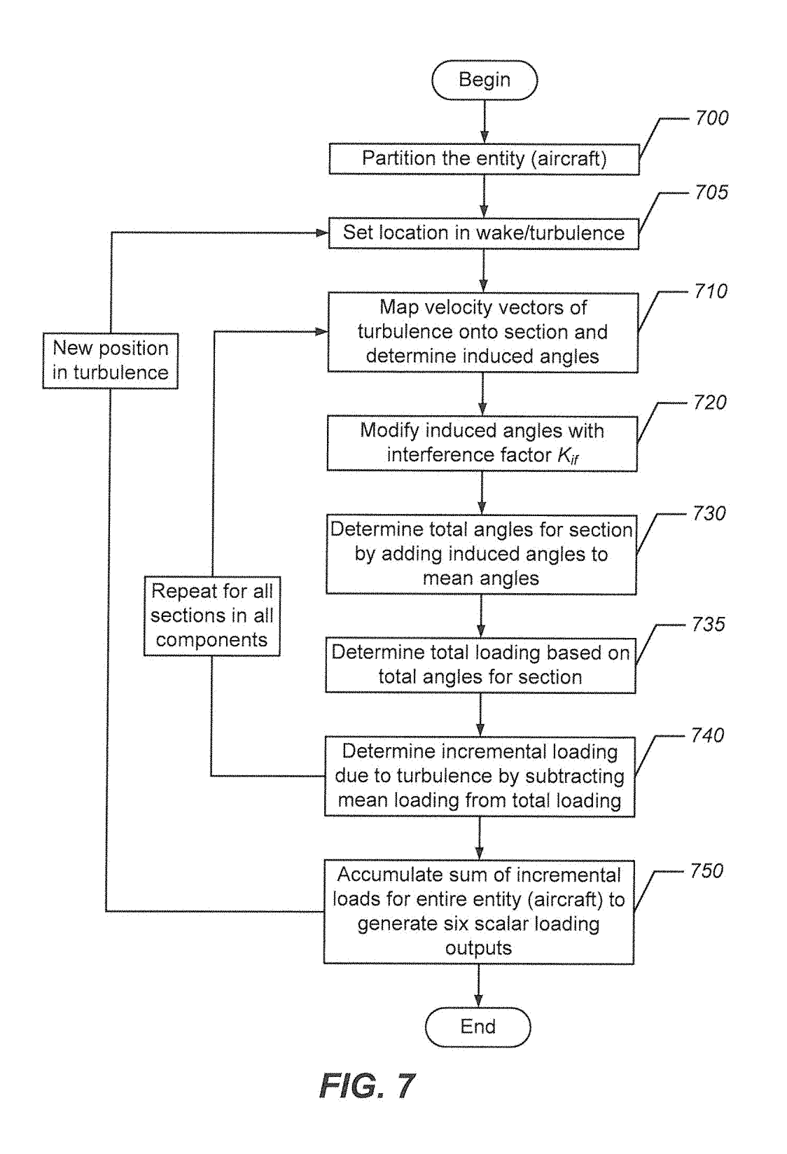

The data processing apparatus of FIGS. 1, 3, and 4 may be used to facilitate determining the effect of turbulence on an entity according to various embodiments described herein. These apparatus may be embodied as one or more enterprise, application, personal, pervasive and/or embedded computer systems and/o, apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media, in particular, the memory 306 coupled to the processor 308 and the memory 405 coupled to the processor 400 include computer readable program code that, when executed by the respective processors, causes the respective processors to perform operations including one or more of the operations described herein with respect to FIG. 7.

FIG. 7 is a flowchart that illustrates operations for facilitating determining the effect of turbulence on an entity in accordance with some embodiments of the inventive subject matter.

Operations begin at block 700 where the partition module 425 partitions an entity, such as an aircraft into one or more components with each component comprising one or more sections. At block 705, the induced angle generation module 430 uses the relative location information repository 106 to obtain a range of the turbulence or wake and a particular location of the entity in the turbulence or wake. For the current location or the entity or aircraft, the induced angle generation module 430 maps the velocity vectors of the turbulence or wake onto the particular section of a component at block 710 to determine the induced angles, α_{ind} and β_{ind}, that the wake or turbulence is imposing on the section. The induced angles, α_{ind} and β_{ind}, may be modified using the interference factor K_{IF} at block 720 to account for low-speed coupling effects. At block 730 the loading estimation module 435 may use a technique called the total angle technique in which the mean angles, αₘₑₐₙ and βₘₑₐₙ, for the current entity conditions or aircraft flight conditions are added to the induced angles, α_{ind} and β_{ind}, for the particular section to obtain total angles α_{Total} and β_{Total}. The total angles, α_{Total} and β_{Total}, may then be used to perform bilinear interpolation in the distributed aeromodel or distributed loads information repository 102 to obtain the total forces and moments acting on the particular section at block 735. The loads corresponding to the mean state of the entity or aircraft may then be subtracted from the total forces and moments or total loads to obtain the incremental forces and moments or incremental loads due to the wake or turbulence for the particular section at block 740.

Blocks 710 through 740 are repeated for each section of each component of the entity or aircraft and the incremental loads are summed across all of the sections and components of the entity or aircraft at block 750 to obtain the six scalar loading outputs FX, FY, FZ, MX, MY, MZ representing the incremental force and moments imposed on the entity or aircraft as a result of the wake or turbulence for a particular position in the wake or turbulence field. These loading, outputs FX, FY, FZ, MX, MY, MZ may be communicated to the flight training client 125 using the communication module 440 for use in a variety of applications in accordance with various embodiments of the inventive concept. These applications may include, but are not limited to, autopilot training and development, human pilot training simulations, flight warning pattern systems, flight coordination systems, flight pattern optimization systems, and the like.

The operations of blocks 705 through 750 may be repeated to obtain determine the incremental force and moments imposed on the entity or aircraft for a new position within the wake or turbulence field.

Embodiments of the inventive concept have been described above by way of example in which a first aircraft, such as a fuel tanker, creates a wake or turbulence that may impose loading on a second aircraft that is approaching the first aircraft to re-fuel in flight Embodiments of the inventive concept may also determine the effect of turbulence or wake generated by the second aircraft on the first aircraft The feed forward effect of the receiver may be largely due to the wing loading of the trailing aircraft; as such, the correction may be based on a 3-D Vortex Filament theory. In this approach, the receiver aircraft is treated as a point vortex and its location relative to the tanker provides the means for determining induced velocities on the tanker. These induced velocities may be accounted for in two separate ways: First is an averaged incremental change in the tanker aircraft states, which drives the tanker aircraft flight dynamics response. Second is a more in depth component level breakdown which follows a process similar to that described above with respect to the receiver aircraft.

Further Definitions and Embodiments:

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented, programming language such as Java, Scala, Smalltalk, Eiffel, JADE, Emerald C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages, such as MATLAB. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through, any type of network, including a local area network (LAN) or, a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can he implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block, or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause, a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the, architecture, functionality, and operation of possible implementations of systems, methods, and computer program products according to various aspects of the present disclosure, in this regard, each block in the flowchart or block diagrams may represent a module, segment, or portion of code, which comprises, one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and, combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

Many variations and modifications can be made to the embodiments without substantially departing from the principles of the present invention. All such variations and modifications are intended to be included herein within the scope of the present invention. The aspects of the disclosure herein were chosen and described to best explain the principles of the disclosure and the practical application, and to enable others of ordinary skill in the art to understand the disclosure with various modifications as are suited to the particular use contemplated.

That which is claimed:

1. A method, comprising:
performing by a processor:
determining a location of an entity within a simulated turbulence, determining induced angles imposed on the entity, wherein determining the induced angles comprises mapping velocity vectors of the simulated turbulence onto the entity;
determining total angles imposed on the entity, wherein determining the total angles comprises adding the mean angles imposed on the entity in an absence of the simulated turbulence to the induced angles;
determining a total loading imposed on the entity based on the total angles imposed on the entity; and
determining an incremental loading imposed on the entity, wherein determining the incremental loading comprises subtracting a mean loading imposed on the entity in the absence of simulated turbulence from the total loading.

2. The method of claim 1, wherein the induced angles comprise an angle-of-attack and a yaw angle.

3. The method of claim 1, wherein mapping the velocity vectors comprises:
determining a centroid of the entity; and
selecting the velocity vectors as being ones of a plurality of velocity vectors that are closest to the centroid of the entity.

4. The method of claim 3, wherein determining the induced angles comprises:
determining turbulence velocities at the centroid, wherein determining the turbulence velocities at the centroid comprises performing a trilinear interpolation of the velocity vectors that were selected; and
determining the induced angles based on the turbulence velocities at the centroid.

5. The method of claim 4, further comprising:
modifying the induced angles using a coupling factor.

6. The method of claim 5, wherein the entity is an aircraft and the coupling factor is based on Max Munk's induction factor.

7. The method of claim 5, wherein the entity is an aircraft and the coupling factor is based, on Oswald's efficiency factor.

8. The method of claim 1, wherein determining the total loading comprises:
performing bilinear interpolation, of the total loading in a loading information repository that relates loading of entity to an applied freestream turbulence vector.

9. The method of claim 1 wherein determining, the incremental loading comprises;
determining incremental force outputs in each of three dimensions; and
determining incremental moment outputs in each of the three dimensions.

10. The method of claim 1, wherein the entity is a portion of an aircraft.

11. A method, comprising:
performing by a processor:
determining a partition of an entity that defines a plurality of entity sections;
performing operations as follows for each respective one of the plurality of entity sections:
determining a location of a respective one of the plurality of entity sections within a simulated turbulence;
determining induced angles imposed on the respective one of the plurality of entity sections, wherein determining the induced angles comprises mapping velocity vectors of the simulated turbulence onto the respective one of the plurality of entity sections;
determining total angles imposed on the respective one of the plurality of entity sections, wherein determining the total angles comprises adding the mean angles imposed on the respective one of the plurality of entity sections in an absence of the simulated turbulence to the induced angles;
determining a total loading imposed on the respective one of the plurality of entity sections based on the total angles imposed on the respective one of the plurality of entity sections; and
determining an incremental loading imposed on the respective one of the plurality of entity sections, wherein determining the incremental loading comprises subtracting a mean loading imposed on the respective one of the plurality of entity sections in the absence of simulated turbulence from the total loading; and
determining an incremental loading imposed on the entity, wherein determining the incremental loading imposed on the entity comprises summing the incremental loading determined for each respective one of the plurality of entity sections.

12. The method of claim 11, wherein the induced angles comprise an angle-of-attack and a yaw angle.

13. The method of claim 11, wherein mapping the velocity vectors comprises:
determining a centroid of the respective one of the plurality of entity sections; and
selecting the velocity vectors as being ones of a plurality of velocity vectors that are closest to the centroid of the respective one of the plurality of entity sections.

14. The method of claim 13, wherein determining the induced angles comprises:
determining turbulence velocities at the centroid, wherein determining the turbulence velocities at the centroid comprises performing a trilinear interpolation of the velocity vectors that were selected; and
determining the induced angles based on the turbulence velocities at the centroid.

15. The method of claim 14, further comprising:
modifying the induced angles using a coupling factor.

16. The method of claim 15, wherein the entity is an aircraft and the coupling factor is based on Max Monk's induction factor.

17. The method of claim 15, wherein the entity is an aircraft and the coupling, factor is based on Oswald's efficiency factor.

18. The method of claim 15, wherein the entity is an aircraft, the respective one of the plurality of entity sections corresponds to a wing section of the aircraft, and the coupling factor is represented by a decay function, the decay function being based on a proximity of the wing section of the aircraft to a fuselage of the aircraft.

19. The method of claim 18, wherein the decay function comprises one of a linear decay function, a polynomial decay function, and an exponential decay function.

20. The method of claim 11, wherein determining the total loading comprises:
performing bilinear interpolation of the total loading in a loading information repository that relates loading of the respective one of the plurality of entity sections to an applied freestream turbulence vector.

21. The method of claim 11, wherein the entity is an aircraft.

22. A system, comprising:
a processor; and
a memory coupled to the processor and comprising computer readable program code embodied in the memory that is executable by the processor to perform;
determining a location of an entity within a simulated turbulence;
determining induced angles imposed on the entity, wherein determining the induced angles comprises mapping velocity vectors of the simulated turbulence onto the entity;
determining total angles imposed on the entity, wherein determining the total angles comprises adding the mean angles imposed on the entity in an absence of the simulated turbulence to the induced angles;
determining a total loading imposed on the entity based on the total angles imposed on the entity; and
determining an incremental loading imposed on the entity, wherein determining the incremental loading comprises subtracting a mean loading imposed on the, entity in the absence of simulated turbulence from the total loading.

23. A computer program product, comprising:
a tangible computer readable storage medium comprising computer readable program code embodied in the medium that is executable by a processor to perform:
determining a location of an entity within a simulated turbulence;
determining induced angles imposed on the entity, wherein determining the induced angles comprises mapping velocity vectors of the simulated turbulence onto the entity;
determining total angles imposed on the entity, wherein determining the total angles comprises adding the mean angles imposed on the entity in an absence of the simulated turbulence to the induced angles;
determining a total loading imposed on the entity based on the total angles imposed on the entity; and
determining an incremental loading imposed on the entity, wherein determining the incremental loading comprises subtracting a mean loading imposed on the entity in the absence of simulated turbulence from the total loading.
